(19) United States
(12) Patent Application Publication
(10) Pub. No.: US 2007/0298841 A1
(43) Pub. Date: Dec. 27, 2007

(54) Approach for Module Configuration Management for an Integrated Telecommunication Platform

(75) Inventor: Yongkun Liao, Shenzhen City (CN)

Correspondence Address: ERIC CHAN, 42 PIN OAKS DRIVE, PHOENIXVILLE, PA, 19460, US

(73) Assignee: Shenzhen Donjin Communication Tech Co., Ltd., Futian District, Shenzhen (CN)

(21) Appl. No.: 11/577,320

(22) PCT Filed: Jul. 26, 2006
(86) PCT No.: PCT/CN06/01861

§ 371 Date: Apr. 14, 2007

(30) Foreign Application Priority Data
Sep. 2, 2005 (CN) 200510037035.3

(51) Int. Cl. H04B 1/38

(52) U.S. Cl. 455/557

(57) ABSTRACT

An approach for module configuration management for an integrated telecommunication platform including the following steps: (a) the configuration management module sends the start instruction to the functional module and the digital signal processing module to start them respectively, and make the connection between the successfully started modules and the already started modules related to them; (b) the configuration management module sends the status detecting instruction to the functional module and the digital signal processing module, which will respectively feed back their current status to the configuration management module after they have received such a detection instruction; (c) the configuration management module will send instructions to the modules at upper level and those at lower level of the functional module and/or the digital signal processing module to disconnect them if the module is abnormal and does not feed back its status signal to the configuration management module. The Invention makes the CTI service expansion easier and more convenient by using the centralized configuration and control over the functional modules and digital signal processing module.

### BACKGROUND OF THE INVENTION

This invention relates generally to the field of telecommunication, especially a module configuration management approach for an integrated telecommunication platform.

As the development of telecom services, the focus has been shifted from voice services to value-added services for a better revenue. The need towards value-added services naturally generates the need for platform equipment of such value-added services. However, the value-added services have the following features: (1) the service need is usually very urgent, demanding the service carrier/manufacturer to release the equipment quickly and if the service is well accepted by people then the system needs to be expanded for a big capacity; (2) the needs for value-added services keep changing rapidly: typically a kind of service will be replaced by another in one or two years, therefor, the equipment cost (both hardware and software) is also a critical factor determining whether the service will be popular or not.

Considering the aforesaid features of the value-added service equipment, the current computer telephony integration (CTI) system has three major defects: first, the complexity of API in current system makes the equipment R&D cycle very long and the soft cost can be very high; second, the structure design is not so good, making the “hard” unit cost is quite high and the “hard” cost of the whole equipment is high therefor; third, the single-board processing density and the cascade expandability can not satisfy the need for high density and expandability of some systems.

### BRIEF SUMMARY OF THE INVENTION

The Invention aims to provide a module configuration management approach for an integrated telecommunication platform to overcome the defects of the current systems in terms of high cost of hardware and software and difficulty in functional expansion.

The technical solution of the Invention to solve the technical issue concerned is: developing a module configuration management approach to configure and control the functional modules and the digital signal processing modules, including the following steps:
(a) the configuration management module sends the start instruction to the functional module and the digital signal processing module, which are expected to be connected with, to start them respectively, and make the connection between the so started modules and the already started modules related to them;
(b) the configuration management module sends the status detecting instruction to the functional module and the digital signal processing module, which will respectively feed back their current status to the configuration management module after they have received such a detection instruction respectively;
(c) if any functional module or digital signal processing module is abnormal and does not feed back its status signal to the configuration management module, the configuration management module will send instructions to the modules at upper level and those at lower level of the fault one to disconnect it.

In accordance with another feature of the invention, the configuration management module will bind an IP address for the digital signal processing module in waiting status.

In accordance with an additional feature of the invention, the concept of functional module means the media flow module, signaling module, process execution module, user module, status monitoring module and one or more configuration management modules.

In accordance with again an added feature of the invention, the Step (a) includes the follows:
(a1) the configuration management module sets the connection with the functional modules and the digital signal processing module according to the configuration data;
(a2) the configuration management module sends the initializing instruction to the functional modules and the digital signal processing module after successfully connected to complete the setup of initialization parameters for them;
(a3) the configuration management module sends the start instruction to the functional modules and the digital signal processing module after successful setup of initializing parameters;
(a4) After the aforesaid functional modules and the digital signal processing module have been successfully started, the configuration management module will mark them with a flag of Already in Running and transmits the related information of them to the running module at upper level and transmits the related information of the running module at upper level to them.

In accordance with again an additional feature of the invention, the aforesaid configuration data includes the IP address of any module in the system and its functional module information related to any other module.

In accordance with again another feature of the invention, the Step (c) includes the following:
(c1) if the configuration management module has not received the status packet from a functional module or a digital signal processing module within the set time, it will mark the corresponding module as a connection interrupted one;
(c2) the configuration management module will send the information of the module marked interrupted to the modules at upper level and those at lower level to disconnect the failed module.

In accordance with again a further feature of the invention, TCP/IP is applied for the communication among the configuration management module, functional modules and the digital signal processing modules.

In accordance with yet an added feature of the invention, the system can use the configuration management module to mark the status of any functional module or digital signal processing module Disconnected to stop the running of the same.

In accordance with yet an additional feature of the invention, in case the configuration management module get any status signal feed back from any fault functional module or digital signal processing module, it will periodically send the status detecting instruction to the failed module.

The Invention makes the CTI service expansion easier and more convenient by using the centralized configuration and control over the functional modules and digital signal processing module.

### BRIEF DESCRIPTION OF THE DRAWINGS

Illustrations and examples are provided herein for further explanation on the Invention. The illustrations cover:

FIG. 1 represents the architecture of the system applying the Invention;

FIG. 2 represents the structure of the digital signal processing module in FIG. 1;

FIG. 3 represents the modules of the system in FIG. 1;

FIG. 4 represents the digital signal processing module in FIG. 3;

FIG. 5 represents the flow chart of the Invention.

### DETAILED DESCRIPTION OF THE INVENTION

FIG. 1 represents the architecture of a system applying the Invention. In this case, the system includes one or more Digital Signal Processing (DSP) Module 11—the minimum hardware unit processing real-time signals (e.g. voice signal). Different DSP modules 11 are independent from each other. DSP modules 11 are connected via CT-BUS for communication between each other, and each of them is also connected to PSTN via communication.

Each DSP Module 11 is also connected to the Network Switch 12 via Ethernet (e.g. twisted pair line), and the Network Switch 12 is connected to one or more Host 13 via Ethernet. Each Host 13 includes one or more functional modules (not indicated in FIG. 1) for such functions as recording and playback of data stream, connection setting and data frame monitoring (refer to FIG. 3 for detailed descriptions for the functional modules). The Network Switch 12 can be used for transmission of Ethernet protocol frames.

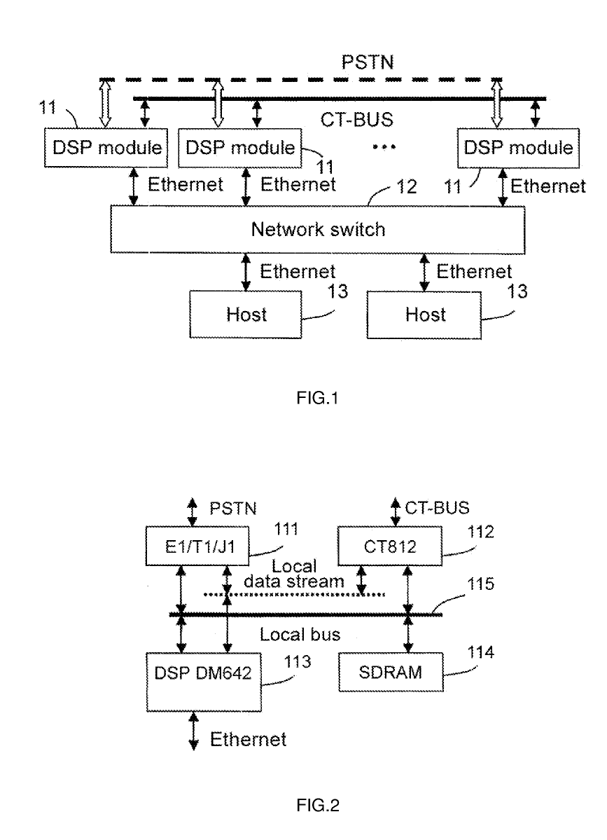

FIG. 2 represents the structure of the Digital Signal Processing Module 11 in FIG. 1. In this case, the DSP Module 11 simultaneously completes processing of voice signals and signalings of layer 2, including E1/T1/J1 PSTN Interface 111, CT812 Chip 112, DM642 Chip 113 and SDRAM 114. E1/T1/J1 PSTN Interface 111, CT812 Chip 112, DS Chip 113 and SDRAM 114 are connected to local bus 115 respectively. DSP Module 11 is connected to PSTN via E1/T1/J1 PSTN Interface 111 and to other DSP modules via CT812 Interface 112. DSP Chip 112 adopts high-performance TMS320DM642 and provides over 4800 MIPS processing capabilities. A single chip can process all signalings and voice signals from four E1 on a real-time basis. In this case, each DSP Module 11 has an exclusive IP address.

FIG. 3 represents all the modules of the system in FIG. 1. Host 13 includes multiple functional modules, such as Media Streaming Module 131, Signaling Module 132, Process Execution Module 133, User Module 134, Status Monitoring Module 135 and Configuration Management Module 136, which are based on certain hardware to provide specific functions. Each functional module is independent from each other. They can be located on the same Host 13 or distributed on different interconnected hosts. Each functional module has the same IP address as the host on which it is installed. If a host has more than one functional module on it, such modules have the same IP address and different configuration management sides. Each functional module includes a network client side submodule and network service side submodule (not indicated in the figure) for communication with other modules.

Among the aforesaid functional modules, except the configuration management module 136, every other functional module has a standard program framework which is unrelated to its function. This will ensure that the integrated telecommunication service system has the best universality, which meets the actual operational needs without any program amendment and only change of the external definition files and the process definition are needed if necessary. The standard framework includes: inter-module communication mode; standard data structure and standard program process.

TCP/IP protocol is used in an implemented case for the inter-module communication. Each ITP module is connected with the TCP service side sub-module of the related inferior module through TCP client side, and is connected with the TCP client side of the related superior module by offering the TCP service side sub-module.

In the shown example, the standard data structure includes a connection list used for managing the status of connecting with the other related modules. The connection lists of all modules can be divided into three categories: a. connected to the configuration management module (one); b. connected to inferior module (one or more); c. connected to superior module (one or more). When the module is just started the connection list will be cleared which indicates that there is no effective connection. During operation whenever it is connected with another related module the corresponding item on the connection list is set to an effective value. When the connection is removed the corresponding item will be set to 0.

In the shown example, the standard program process includes: (1) Load the configuration information (if necessary) after starting the module and process it, then initialize the data. (2) Set parameters of the TCP service side sub-module, and monitor the access of other modules' client sides. (3) Check if there is connection of any legal client side with the current module's service side sub-module. If there is such connection put it into the connection list of current module. (4) Check if there is any configuration management packet from the configuration management module received. Go to step (5) if there is. Clear the corresponding item on the connection list and go to step (6) if disconnected. (5) Process the configuration management packet and go to step (4). (6) Check and process the communication packets received from inferior modules. (7) Process the communication packets to be sent to the inferior module. (8) Check and process the communication packets received from the superior module and go to step (3).

The media stream module 131 is used for recording and playing of the media data based on the digital signal processing module 11. The signaling module 132 is used for processing the signaling protocol of third level or above of No. 7 signaling and Q.931 signaling protocol of digital No. 1 signaling. The flow execution module 133 is used for realizing the controlling of system working process and fulfilling the service demand of CTI. The user module 134 is used for processing of the applications unrelated to CTI functions, such as database processing. This user module 134 is programmed by the user. and it is not a must module in this case. The aforesaid media stream module 131, signaling module 132, flow execution module 133 and user module 134 are all in a waiting status after system started. One of ports at the network service side sub-module monitors the control information from the configuration management module 136, and execute certain operations according to the control information received.

The configuration management module 136 is the core of the integrated telecommunication service system. Each functional module operates according to the control instructions of the configuration management module 136. in this implemented case, each digital signal processing module 11 has a sole MAC address. The configuration management module 136 will bind such MAC addresses to the IP address set by the configuration management module. Besides, the configuration management module 136 will get the IP addresses and the configuration management ports of the functional modules of the access system, based on which the configuration management module 136 will set up connections and configure the modules. Then it can pass the address information to the related modules and send out the control instructions to start such modules to a normal working process. During the normal working process the configuration management module 136 will carry out the functions of monitoring the module operation status, stop/start and add/delete modules etc. The execution of the configuration management module is further described in FIG. 5.

In the shown example, the media stream modules 131 and the signaling modules 132 can be related to the digital signal processing modules 11. The flow execution module 133 can be related to digital signal processing module 11, media stream module 131 and signaling module 132. The information is transmitted among related modules through Ethernet protocol frames, thus services of the integrated telecommunication service system are realized.

The configuration management module 136 can control the functional modules to go into different working status, including: disconnected; connected; operating normally, etc. Besides controlling and displaying the working status of each module, the configuration management module 136 shall monitor regularly the working status of operating functional modules in order to figure out any failed module.

The status monitoring module 135 is used for monitoring the content of communication packets among other modules which is realized though the following method: the status monitoring module 135 sends a monitoring request to the configuration management module 136 who will then pass the request to the relevant functional modules. Then the relevant functional modules will transmit a copy of the communication packets to the status monitoring module 135.

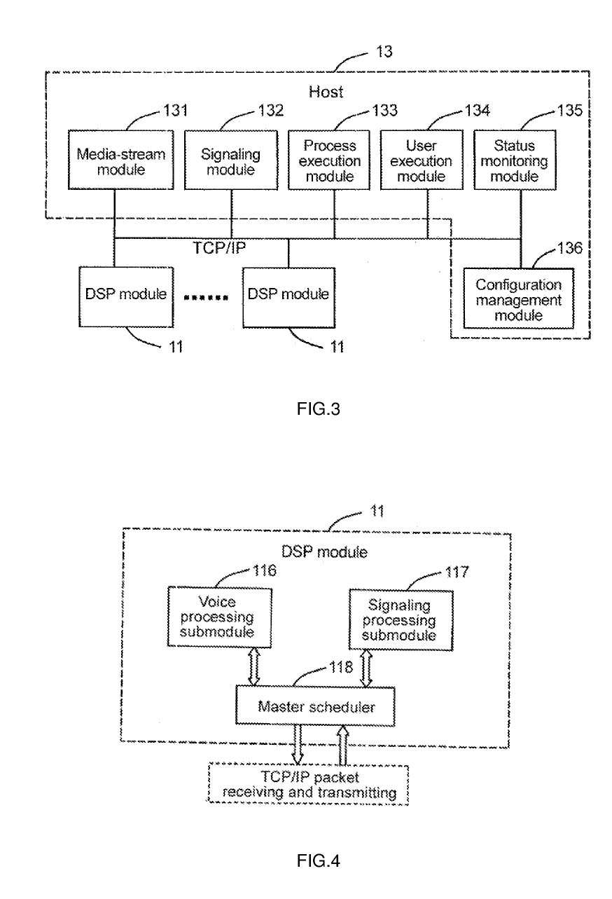

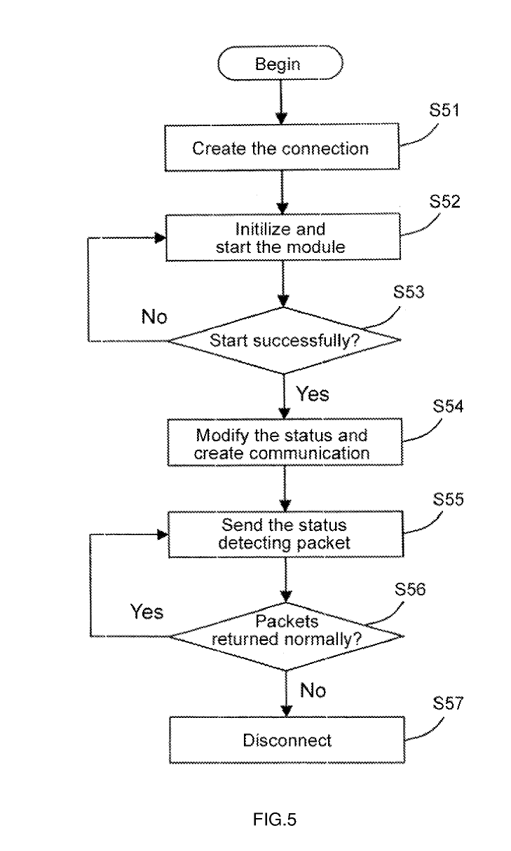

The FIG. 4 shows the digital signal processing module 11 in FIG. 3, which functionally consists of the voice processing sub-module 116 and the signaling processing sub-module 117. The voice processing sub-module 116 is used for processing all voice signals. The signaling processing sub-module 117 includes a four-channel signaling processing unit and a receiving/transmitting frame format controlling and monitoring unit. Three options are available for setting the working mode of each signaling processing unit: SS1, DSS1 and SS7. When SS1 mode is set each unit will process 30 channels of DL signalings for one E1; when DSS1 mode is selected, each unit will process one Q.921 link; for SS7, each unit will process one MTP2 link. The frame format controlling and monitoring unit will fulfill the controlling and monitoring over receiving/transmitting frame format of four E1s and the alarming processing, etc.

After data from voice processing sub-module 116 and signaling processing submodule 117 have been encapsulated as Ethernet protocol frames by Master Scheduler 118, such Ethernet protocol frames are transmitted to the functional module for further processing, or, after master scheduler 118 has processed the frames from functional module or configuration management module 136, the frames are transmitted to voice processing sub-module 116 or signaling processing submodule 117 for processing.

FIG. 5 represents the flow chart of the Approach of the Invention. When configuration management module 136 is started, it sets up connection with the other started modules (including functional modules and digital signal processing modules) in real-time in accordance with the configuration information. In the shown example, configuration information contains such address information as IP address and port of any functional module of the system etc. (including MAC address message in case of a DSP voice processing module). Such address information allows the configuration management module to set up the connection with the functional modules. Meanwhile, configuration information of a functional module also includes information of other functional modules related to it, including subordinate functional modules and superior functional module directly related to this functional module. When any module is started or stopped, such related module information allows the configuration management module to send the Relate or Dis-relate instruction packets to notify the related modules for corresponding processing in time. Configuration information of a module can be set or altered and saved before the module is started or after the module is stopped, however, do not alter while running.

Once it is confirmed that connection with a module has been created, the configuration management module 136 will send the initializing instruction to complete setting of initial parameters of the functional module; After successful initialization, the configuration management module 136 sends the start instruction to the module to start it (Step S52), and then identify whether the module succeeded in starting (step S53) based on the status packet feed back from the module. The aforesaid initialization step include the binding of an IP address for the digital signal processing module.

If the corresponding module does not succeed in starting, i.e. no returned status packet or the returned status packet flag is not a starting one, then the system returns to Step S52. If the corresponding module succeeds in starting, the configuration management module 136 marks the module as running, and transmits the relevant information of the module to all running superior modules (i.e. modules directly using the module) as well as transmits the relevant information of all running superior modules to the module (through module relating instruction packets). The module relating instruction packets allow the modules to set up communication with the related modules and use their functions in a timely manner (Step S54).

For the running modules, configuration management module 136 sends heartbeat packets regularly (packets for detecting the module status). When a running module receives a heartbeat packet from the configuration management module 136, the status of the running module will be feed back to the configuration management module with the status packet (Step S56). Then, the configuration management module 136 identifies whether the module has already been disconnected based on the whether or not receiving the status packet or the status flag of the status packet fed back (Step S56). If a certain module is disconnected, i.e. the configuration management module 136 receives no status packet from the module or the status flag of the status packet fed back indicates that the module is disconnected, then the configuration management module 136 marks the status of the module as disconnected and sends this module information to the relevant superior and subordinate modules (a subordinate module is defined as a module directly used by the module), and then relevant modules can cut off connection with the failed module and stop using its functions (Step S57). If a module is not disconnected, then the system returns to Step S55.

When the user intervenes voluntarily and stops running of a module, configuration management module 136 sets this targeted module status as disconnected, and send such module information to the relevant superior and subordinate modules, then relevant modules can cut off their connection with the failed module and stop using their functions in a timely manner. Then, with the configuration management model 136, expansion of CTI services becomes comparatively easier and more convenient.

The above paragraphs are just some examples of practice of the Invention instead of any limitation in any form to the Invention. Any simple modification, amendment, revision, equivalent change or embellishment with the technical essence of the Invention falls into the technical solution and claims of the Invention.

What is claimed is:

1. It's a module configuration management approach for an integrated telecommunication platform, focusing on configuration and control over the functional modules and the digital signal processing modules, the technical features include the following steps:
(a) the configuration management module sends the start instruction to the functional module and the digital signal processing module, which are expected to be connected with, to start them respectively, and make the connection between the so started modules and the already started modules related to them;
(b) the configuration management module sends the status detecting instruction to the functional module and the digital signal processing module, which will respectively feed back their current status to the configuration management module after they have received such a detection instruction respectively;
(c) if any functional module or digital signal processing module is abnormal and does not feed back its status signal to the configuration management module, the configuration management module will send instructions to the modules at upper level and those at lower level of the fault one to disconnect it.

2. The invention of claim 1, wherein the configuration management module also binds an IP address for the digital signal processing module in waiting status.

3. The invention of claim 1, wherein the concept of functional module means the media flow module, signaling module, process execution module, user module, status monitoring module and one or more configuration management modules.

4. The invention of claim 1, wherein the Step (a) includes the following steps:
(a1) the configuration management module sets the connection with the functional modules and the digital signal processing module according to the configuration data;
(a2) the configuration management module sends the initializing instruction to the functional modules and the digital signal processing module after successfully connected to complete the setup of initialization parameters for them;
(a3) the configuration management module sends the start instruction to the functional modules and the digital signal processing module after successful setup of initializing parameters;
(a4) After the aforesaid functional modules and the digital signal processing module have been successfully started, the configuration management module will mark them with a flag of Already in Running and transmits the related information of them to the running module at upper level and transmits the related information of the running module at upper level to them.

5. The invention of claim 1, wherein the configuration data includes the IP address of the module in the system and its functional module information relating the module to any other module in the system.

6. The invention of claim 1, wherein the Step (c) includes the following steps:
(c1) if the configuration management module has not received the status packet from a functional module or a digital signal processing module within the set time, it will mark the corresponding module as a connection interrupted one;
(c2) the configuration management module will send the information of the module marked interrupted to the modules at upper level and those at lower level to disconnect the failed module.

7. The invention of claim 1, wherein the configuration management module, functional modules and the digital signal processing modules are connected with TCP/IP protocols.

8. The invention of claim 1, wherein the system may use the configuration management module to mark the status of any functional module or digital signal processing module Disconnected to stop the running of the same.

9. The invention of claim 1, wherein the configuration management module will periodically send status detecting instructions to a failed module in case it get any status signal feed back from the fault functional module or digital signal processing module.
